(19) United States
(12) Patent Application Publication
(10) Pub. No.: US 2016/0248943 A1
(43) Pub. Date: Aug. 25, 2016

(54) IMAGE FORMING APPARATUS AND METHOD OF CONTROLLING IMAGE FORMING APPARATUS

(71) Applicant: CANON KABUSHIKI KAISHA, Tokyo (JP)

(72) Inventor: Ken Yokoyama, Mishima-shi (JP)

(21) Appl. No.: 15/042,699

(22) Filed: Feb. 12, 2016

(30) Foreign Application Priority Data
Feb. 24, 2015 (JP) 2015-034126

(51) Int. Cl. H04N 1/60; G03G 15/00

(52) U.S. Cl. CPC H04N 1/6075; G03G 15/5025

(57) ABSTRACT

The image forming apparatus configured to execute density control, includes a printer engine configured to indicate a plurality of images obtained by changing an image level in a stepwise manner, and a CPU configured to determine whether or not the density control is to be executed based on an allowance level selected from among the image levels corresponding to the plurality of images and on information on whether or not the density control is to be executed, which is set for each image level.

### BACKGROUND OF THE INVENTION

1. Field of the Invention

The present invention relates to an image forming apparatus and a method of controlling an image forming apparatus and, for example, to a method of controlling an image forming apparatus employing an image quality maintaining process for adjusting an image forming condition according to a temporal change, an environmental change, or the like.

2. Description of the Related Art

In recent years, the electrophotographic color type of image forming apparatuses, such as a color printer or a color copying machine, has been required to achieve stability of a fixed image formed on a transfer material (the fixed image hereinafter referred to as “output image”). In particular, the stability of density, the balance among color components, or misregistration affects the quality of an image, and hence it is necessary to execute a process for maintaining the image quality (hereinafter referred to as “image quality maintaining process”) at regular intervals. It is desired that the image quality maintaining process be executed in a manner not to affect a printing operation. However, when the image quality maintaining process cannot be executed in parallel to the printing operation, the image quality maintaining process needs to be executed after the printing operation is stopped, which may lower the productivity of the image forming operation. For example, in Japanese Patent Application Laid-Open No. H04-036776, there is discussed about the density control as the image quality maintaining process of an electrophotographic color image forming apparatus. The density control is, for example, the following control. A gradation pattern containing a plurality of toner images for density detection (hereinafter referred to as “patch”), which are formed from toner of each color, is formed on an intermediate transfer member or a photosensitive member, and the density of each of the formed patches that are unfixed is detected by a sensor for density detection (hereinafter referred to as “density sensor”). Then, based on detection results obtained by the density sensor, the relation between image data and the density (hereinafter referred to as “gamma”) is controlled so that a predetermined gamma is attained. The density control is executed when there is a fear of decrease in stability of the density, such as when an environmental change is observed because temperature or humidity inside the image forming apparatus has changed by more than a certain set value, or when it is predicted that a charged state of a developer or a photosensitive member may change due to repeated printing or the like. There is a problem in that the printing operation cannot be executed during the execution of the density control, which lowers the productivity.

At the same time, the execution of the image quality maintaining process at a predetermined frequency or time is not necessarily appropriate according to a user who uses the image forming apparatus. The degree of abnormality of a formed image at which a user recognizes its abnormality (abnormality recognition degree (also referred to as “abnormality recognition level”)) differs for each individual, and also differs according to the type of image. For example, even when the image quality maintaining process is executed at a predetermined frequency, the stability of the image quality may not satisfy the requirement of a user who puts emphasis on the image quality. On the other hand, even when the image quality maintaining process is executed at the same predetermined frequency, a user who does not put much emphasis on a change in image quality may feel that the image quality maintaining process is executed excessively. For such user, lowering of productivity due to downtime caused by the image quality maintaining process is more important than lowering of the image quality. Further, taking the density control as an example, a photographic image and a graphics image are snore liable to be affected by a density change compared to a text image.

In this connection, there has been proposed configuration in which time to execute the image quality maintaining process is allowed to be set from outside as illustrated in FIG. 7 (e.g., Japanese Patent Application Laid-Open No. 2004-23767). Note that, details of FIG.7 are described later. According to this configuration, an execution frequency of image quality maintaining process includes a plurality of modes, such as an “image priority mode” and a “productivity priority mode”, can be set, and one of the modes is selected by the user. With this, an appropriate balance between the productivity and the image quality can be selected in a manner that suits the user's situation.

However, in the related-art method of selecting the execution frequency of the image quality maintaining process including the plurality of modes, such as the “image priority mode” and the “productivity priority mode”, the following problem exists. Specifically, unless an image is output, after one of the modes is selected, cannot be determined whether or not the level of stability of image quality falls within a predetermined range at least until the next image quality maintaining process. Therefore, when the level of stability of image quality does not fall within the predetermined range, work such as selecting another mode again is required. As described above, in the related art, although the execution frequency of the image quality maintaining process can be changed easily, the user's requirement may not be satisfied in some cases. Moreover, when the level of stability of image quality does not fall within the predetermined range, the execution frequency needs to be adjusted again, which may lower usability

### SUMMARY OF THE INVENTION

An object of the present invention is to provide an image forming apparatus configured to execute image adjusting control, including an indicating unit configured to indicate a plurality of images in which an index related to quality of an image is changed in a stepwise manner; and a determination unit configured to determine whether or not the image adjusting control is to be executed based on the index corresponding to an image selected from among the plurality of images and on information on whether or not the image adjusting control is to be executed, the information being set for each index changed in a stepwise manner.

Another object of the present invention is to provide a method of controlling an image forming apparatus configured to execute image adjusting control, the method including, providing, by an indicating unit, a plurality of images in which an index indicating quality of an image is changed in a stepwise manner; selecting one image from among the plurality of images; and determining whether or not the image adjusting control is to be executed based on the index corresponding to the selected image and on information on whether or not the image adjusting control is to be executed, the information being set for each index changed in a stepwise manner.

Further features of the present invention will become apparent from the following description of exemplary embodiments with reference to the attached drawings,

### BRIEF DESCRIPTION OF THE DRAWINGS

FIG. 1A is a block diagram for illustrating an overall configuration of a color image forming apparatus according to first to third embodiments of the present invention.

FIG. 1B is a cross-sectional view for illustrating the color image forming apparatus according to the first to third embodiments.

FIG. 2 a diagram for illustrating a configuration of a density sensor according to the first and second embodiments.

FIG. 3 is a flowchart for illustrating processing of storing a table according to the first embodiment,

FIG. 4A is a graph for showing a relation between image data before conversion and image data after conversion according to the first embodiment.

FIG. 4B is a flowchart for illustrating processing of changing an execution frequency of density control.

FIG. 5A is a diagram for illustrating transfer materials that are output according to the first to third embodiments.

FIG. 55 is a diagram for illustrating a plurality of images displayed on a display unit.

FIGS. 6A, 6B and 6C are diagrams for illustrating a configuration of a color sensor according to the third embodiment.

FIG. 7 is a flowchart for illustrating processing of changing an execution frequency of density control according to the related art.

### DESCRIPTION OF THE EMBODIMENTS

Preferred embodiments of the present invention will now be described in detail in accordance with the accompanying drawings.

[Related-Art Processing of Changing Execution Frequency of Image Quality Maintaining Process]

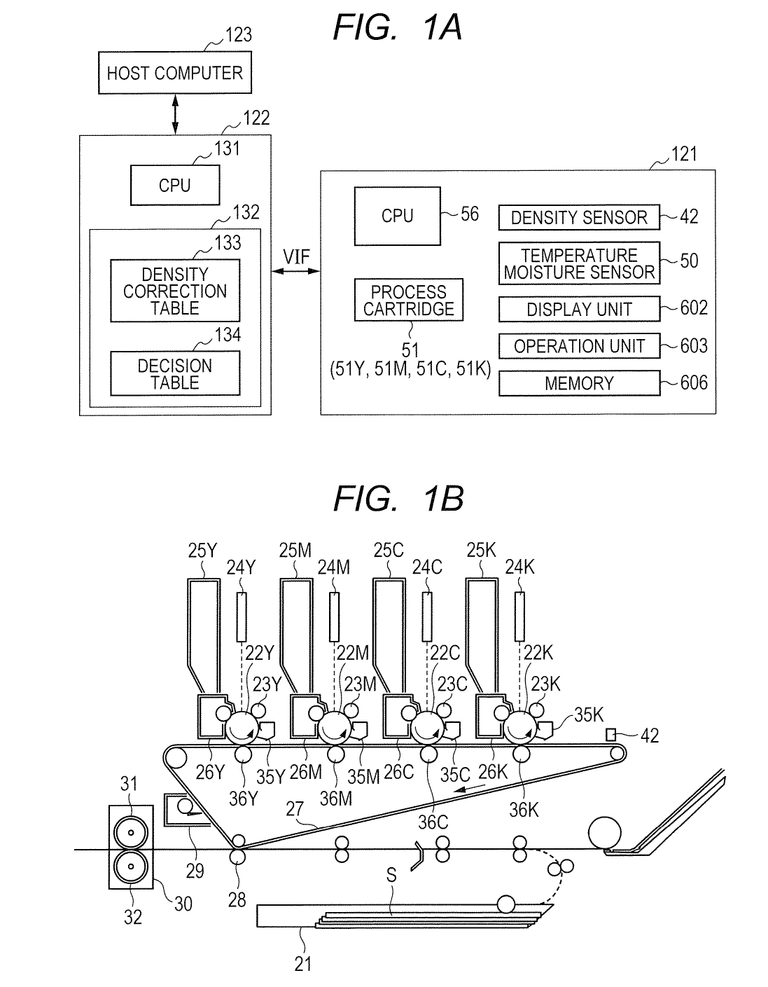

For the purpose of comparison with embodiments of the present invention, related-art processing of changing an execution frequency of an image quality maintaining process that is image adjusting control is described, FIG. 7 is a flowchart for illustrating related-art control processing relating to a determination as to whether or not to give an instruction to execute density correction control (hereinafter also referred to as “density control”), which is executed by a controller 122 (see FIG. 1A) described later. In Step (hereinafter referred to as “S”) 401, a CPU 131, which is described later, of the controller 122 determines whether or not the CPU 131 has received notification of necessity of density control from a printer engine 121 (see FIG. 1A) described later. When the CPU 131 determines in S401 that the CPU 131 has not received the notification of necessity of density control, the CPU 131 ends the control processing. Otherwise, the control processing proceeds to S402. In S402, the CPU 131 determines whether or not a current setting of a printer is set to an “image priority mode”. When the CPU 131 determines in S402 that the current setting of the printer is set to the “image priority mode”, the control processing proceeds to S405. In S405, the CPU 131 transmits an execution command of the density control to the printer engine 121.

When the CPU 131 determines in S402 that the current setting of the printer is not set to the “image priority mode”, that is, the current setting of the printer set to a “productivity priority mode”, the control processing proceeds to S403. In S403, the CPU 131 requests the printer engine 121 to transmit a factor causing the transmission of the notification of necessity of density control (illustrated as “factor of density control execution request”), and then receives information on the factor from the printer engine 121. In S404, the CPU 131 determines whether or not the density control needs to be executed (necessity of the density control) based on the information on the factor of the density control execution request. When the CPU 131 determines in S404 that the density control needs to be executed, that is, that the CPU 131 is to execute the density control, the control processing proceeds to S405. When the CPU 131 determines in S404 that the density control does not need to be executed, that is, that the CPU 131 is not to execute the density control, the CPU 131 ends the control processing without transmitting the execution command of the density control to the printer engine 121.

Information serving as criteria to be used by the CPU 131 in S404 to determine the necessity of the density control based on the information on the factor of the density control execution request is determined based on a specification of the printer engine 121. For example, the information serving as the criteria to be used to determine the necessity of the density control is such information as shown in Table 1. In Table 1, for each factor of the density control execution request, a determination as to whether or not to execute the density control is associated with the factor. Note that, the information of Table 1 is stored into a memory 132 described later as a “factor of density control execution request and determination” table.

TABLE 1

| Factor of density control execution request | Determination |
|---|---|
| Number of transfer materials that have been | Not executed |
| passed reaches 1,000 | |
| Process cartridge is replaced | Executed |
| Transfer unit is replaced | Executed |
| Temperature or humidity is changed by | Not executed |
| predetermined value or more | |
| Printer has been left unused for | Executed |
| predetermined time period | |

In the first column of Table 1, factors of the density control execution request are shown, and the factor that the number of transfer materials that have been passed since the previous execution of the density control reaches 1,000 and the factor that a process cartridge is replaced are given. In addition, in the first column of Table 1, the factor that a transfer unit is replaced, the factor that temperature or humidity is changed by a predetermined value or more, and the factor that the printer has been left unused for a predetermined time period are given. In the second column of Table 1, determination results corresponding to the respective factors are shown, and information on whether or not to execute the density control is stored.

For example, when the printer engine 121 has the following specification: “when the process cartridge is replaced, the printer engine 121 cannot ensure the image quality unless the density control is executed”, this factor is associated with a determination as follows. Specifically, in this case, as shown in Table 1, the factor “Process cartridge is replaced” is associated with the determination “Executed”. In the case of the printer engine 121 having such specification, when the factor of the density control execution request received by the CPU 131 in S403 of FIG. 7 is “Process cartridge is replaced”, the CPU 131 determines that the density control is “Executed”, and the control processing proceeds to S405. On the other hand, when the factor of the density control execution request received by the CPU 131 in S403 of FIG. 7 is “The number of transfer materials that have been passed reaches 1,000”, the CPU 131 determines that the density control is “Not executed” based on the information of Table 1. As described above, while an adjustment for satisfying the image quality is made without fail, the execution frequency of the image quality maintaining process is allowed to be changed by, for example, skipping an adjustment (density control) that may be made unnecessary according to the user's setting.

### First Embodiment

Referring to FIG. 1A to FIG. 4B, a first embodiment of the present invention is described. In this embodiment, a plurality of images obtained by changing a level of image quality in a stepwise manner are output, and from among the plurality of images having different levels of image quality, an image having an allowable level of image quality is selected. Then, based on information on the level of image quality of the selected image, an execution frequency of an image quality maintaining process that is image adjusting control is changed.

[Image Forming Apparatus]

An electrophotographic color image forming apparatus according to this embodiment includes an image processing portion and an image forming unit, and FIG. 1A is a block diagram for illustrating an overall configuration of the color image forming apparatus including the image processing portion and the image forming unit. Further, FIG. 1B is a cross-sectional view for illustrating an overall configuration of the color image forming apparatus serving as the image forming unit, and as an example, a tandem configuration in which an intermediate transfer member is adopted is described. However, the configuration of the image forming apparatus is not limited this configuration. The controller 122 serving as the image processing portion and the printer engine 121 serving as the image forming unit (forming unit) are connected to each other by a video interface (hereinafter referred to as “VIF”), and the controller 122 is connected to a host computer 123 that is an external terminal.

The controller 122 includes the memory 132 serving as a storage unit configured to store execution conditions for a process executed in order to maintain the image quality (hereinafter referred to as “image quality maintaining process”). In the memory 132, as The execution conditions for the image quality maintaining process, the “factor of density control execution request and determination” table 134 (hereinafter simply referred to as “table 134”), which is a configuration specific to this embodiment, is stored. The table 134 according to this embodiment is, as shown in Table 1, a table in which for each factor of the density control execution request, a determination as to whether or not to execute the density control is associated with the factor. Further, in the memory 132, a color matching table (not shown) to be used for color conversion, a color separation table (not shown), a pulse width modulation (PWM) table (not shown), and a density correction table 133 are stored. In the density correction table 133, information determined through the density control is stored, and a method of calculating the information is described later. Further, the controller 122 includes the CPU 131 serving as a determination unit configured to determine whether or not to execute the image quality maintaining process based on the execution conditions for the density control (table 134) stored into the memory 132.

The printer engine 121 includes a density sensor 42, process cartridges 51Y, 51M, 51C, and 51K, and a CPU 56 configured to process a detection result obtained by the density sensor 42. The printer engine 121 further includes a temperature moisture sensor 50, a display unit 602, an operation unit 603 serving as an input unit, which is used when an image level described later is input, to the image forming apparatus, and a memory 606.

Next, processing executed by the controller 122 is described. The CPU 131 uses the color matching table stored in advance into the memory 132 to convert an RGB signal indicating colors of an image transmitted from the host computer 123 or the like into a device RGB signal conforming to a color reproducibility range of the color image forming apparatus. Then, the CPU 131 uses the color separation table stored into the memory 132 to convert the device RGB signal into a CMYK signal conforming to colors of toner materials of the color image forming apparatus. The CPU 131 uses the density correction table 133, which is used for correction of a gradation-density characteristic specific to each color image forming apparatus, to convert the CMYK signal into a C′M′Y′K signal subjected to the correction of the gradation-density characteristic. The CPU 131 performs halftone processing on the C′M′Y′K′ signal after the conversion to convert the C′M′Y′K′ signal into a signal. The CPU 131 uses the PWM table stored in advance into the memory 132 to convert the C″M″Y″K″ signal into exposure times Te, Tm, Ty, and Tk of scanners 24Y, 24M, 24C, and 24K described later, which correspond to the C″M″Y″K″ signal. Note that, the printer engine 121 may include the density correction table 133 and the table 134. In this case, the printer engine 121 may notify the controller 122 of a result of the determination made based on the density correction table 133 and the table 134.

Next, referring to the color image forming apparatus of FIG. 15, an image forming operation is described. The color image forming apparatus includes as many stations as development colors, which are arranged in line, and the process cartridges 51Y, 51M, 51C, and 51K included in the respective stations include photosensitive drums 22Y, 22M, 22C, and 22K serving as photosensitive members, respectively. In this case, “Y” represents yellow, “M” represents magenta, “C” represents cyan, and “K” represents black, and in the following, the suffixes Y, M, C, and K indicating the respective colors are omitted unless otherwise necessary. In the process cartridge 51, a charging roller 23 (23Y, 23M, 23C, or 23K) serving as a charging unit, a cleaner 35 (35Y, 35M, 35C, or 35K) serving as a cleaning unit configured to clean the photosensitive drum 22, a toner container 25 (25Y, 25M, 25C, or 25K), and a developing device 26 (26Y, 26M, 26C, or 26K) serving as a developing unit are arranged. First, the photosensitive drum 22 configured to rotate in the direction of the arrow of FIG. 1B (counterclockwise direction) is charged by the charging roller 23. A light source of the scanner 24 (24Y, 24M, 24C, or 24K) is turned on based on the exposure time Tc, Tm, Ty, or Tk obtained by the conversion by the controller 122, and a surface of the photosensitive drum 22 is selectively exposed by exposure light from the light source, to thereby form an electrostatic latent image on the photosensitive drum 22. Toner is supplied from the developing device 26 to the electrostatic latent image on the photosensitive drum 22, to thereby form a toner image of each color on the photosensitive drum 22.

Further, a primary transfer roller 36 (36Y, 36M, 36C, or 36K) is arranged so as to he opposed to the photosensitive drum 22 and sandwich an intermediate transfer belt 27 between the primary transfer roller 36 and the photosensitive drum 22. The intermediate transfer belt 27 is configured to rotate in the direction of the arrow of FIG. 1B (clockwise direction), and the primary transfer roller 36 is configured to be passively rotated together with the rotation of the intermediate transfer belt 27. Then, due to a potential difference between the primary transfer roller 36 and the photosensitive drum 22, single-color toner image on the photosensitive drum 22 is transferred onto the intermediate transfer belt 27. The single-color toner images on the respective photosensitive drums 22 are transferred, in synchronization with one another, onto the intermediate transfer belt 27 while being superimposed one on another, to thereby form a multi-color toner image on the intermediate transfer belt 27. Meanwhile, the transfer material S is started to be fed from a sheet feeding cassette 21, and the transfer material is conveyed to a nip portion formed between the intermediate transfer belt 27 and a secondary transfer roller 28. The transfer material S is conveyed while being sandwiched between the intermediate transfer belt 27 and the secondary transfer roller 28 under a state in which the secondary transfer roller 28 comes in contact with the intermediate transfer belt 27, and the multi-color toner image on the intermediate transfer belt 27 is transferred onto the transfer material S.

A fixing device 30 fixes, while conveying the transfer material S therein, the unfixed multi-color toner image transferred to the transfer material S by melting the toner image. The fixing device 30 includes a fixing roller configured to heat the transfer material S and a pressure roller 32 configured to bring the transfer material S into pressure-contact with the fixing roller 31. The transfer material S bearing the unfixed multi-color toner image is conveyed while being sandwiched between the fixing roller 31 and the pressure roller 32, and heat and pressure are applied to the transfer material S at the same time, to thereby fix the toner to the surface of the transfer material S. The transfer material S to which the toner image has been fixed is then discharged onto a delivery tray (not shown) by a discharging roller (not shown), and the image forming operation ends. Discharge of the transfer material S bearing the fixed image onto the delivery tray (not shown) is also referred to as “output of the image”. A cleaning device 29 serving as the cleaning unit cleans toner that has been left on the intermediate transfer belt 27 without being transferred onto the transfer material S. Toner that has been left on the intermediate transfer belt 27 after the multi-color toner image, namely, a four-color toner image, formed on the intermediate transfer belt 27 is transferred onto the transfer material S is cleaned by the cleaning device 29, and is collected into a cleaner container accompanying the cleaning device 29. The density sensor 42 is described later.

[Density Sensor]

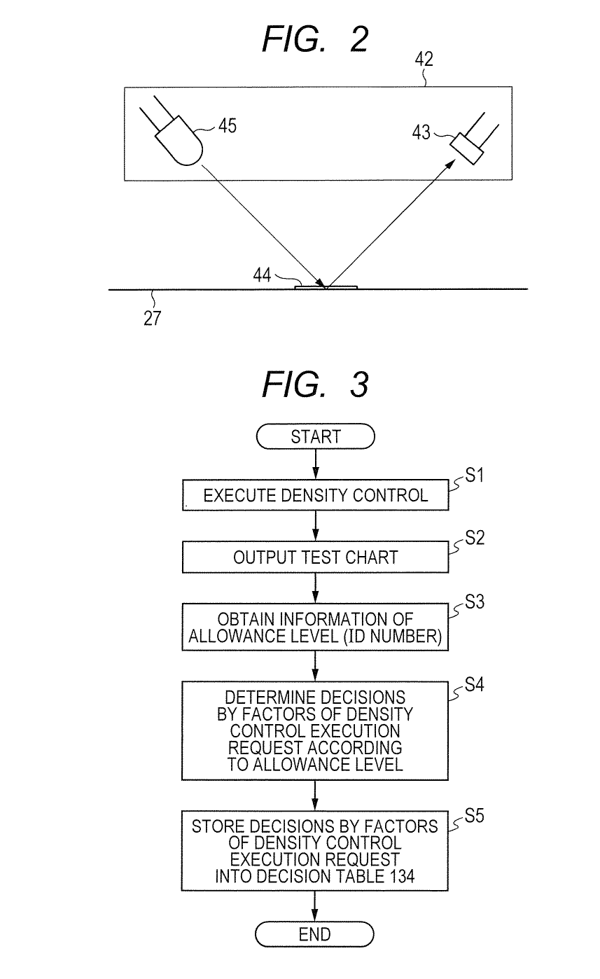

The density sensor 42 is arranged so as to face the intermediate transfer belt 27 and be located at a position corresponding to the center of the intermediate transfer belt 27 in a longitudinal direction thereof (direction orthogonal to a movement direction of the intermediate transfer belt 27). The density sensor 42 detects a toner patch formed on the surface of the intermediate transfer belt and a detection result is used for a measurement of toner density. FIG. 2 is an illustration of an example of a configuration of the density sensor 42. The density sensor 42 includes a light emitting element 45 such as an LED, which is configured to emit light in an infrared wavelength region, a light receiving element 43 such as a photodiode, an IC (not shown) configured to process data output from the light receiving element 43 that has received the infrared light, and a holder (not shown) configured to accommodate those components. The light emitting element 45 is installed at degrees with respect to a normal direction of the intermediate transfer belt 27, and applies the infrared light to a toner patch 44 on the intermediate transfer belt 27. The light receiving element 43 is installed at a position symmetrical to the light emitting element 45 with respect to normal direction of the intermediate transfer belt 27, and detects light specularly reflected by the toner patch 44. Note that, a configuration of the toner patch 44 is known, and hence a description thereof is omitted.

The surface of the intermediate transfer belt 27 is glossy, and hence the light receiving element 43 detects light reflected from the intermediate transfer belt 27 when the surface of the intermediate transfer belt 27 is exposed. On the other hand, when the toner image is formed on the intermediate transfer belt 27, as the density of the toner image increases, a level of an output signal from the light receiving element 43 detecting the specularly-reflected light gradually decreases. This is because the toner covers the surface of the intermediate transfer belt 27 to increase a diffused reflection component and decrease a specular reflection component. Note that, the density sensor 42 use the IC (not shown) to calculate the toner density based on the signal level output from the light receiving element 43 that has received the specularly-reflected light.

[Density Correction Control]

Next, density correction control (image quality maintaining process described above), which is control for maintaining the quality of an image, is described. The density correction control uses a known method Specifically, a plurality of toner patches 44 obtained by changing a gradation are formed on the intermediate transfer belt 27, and the density of each of the toner patches 44 formed on the intermediate transfer belt 27 is measured by the density sensor 42. The CPU 131 calculates a relation between image data and a density (hereinafter referred to as “gamma”) based on the density of each of the toner patches 44 measured by the density sensor 42. Next, the CPU 131 determines the density correction table 133 for converting the image data so that a predetermined gamma can be obtained. Note that, the density correction control is known, and hence a detailed description thereof is omitted,

[Method of Determining Whether or Not to Execute Image Quality Maintaining Process]

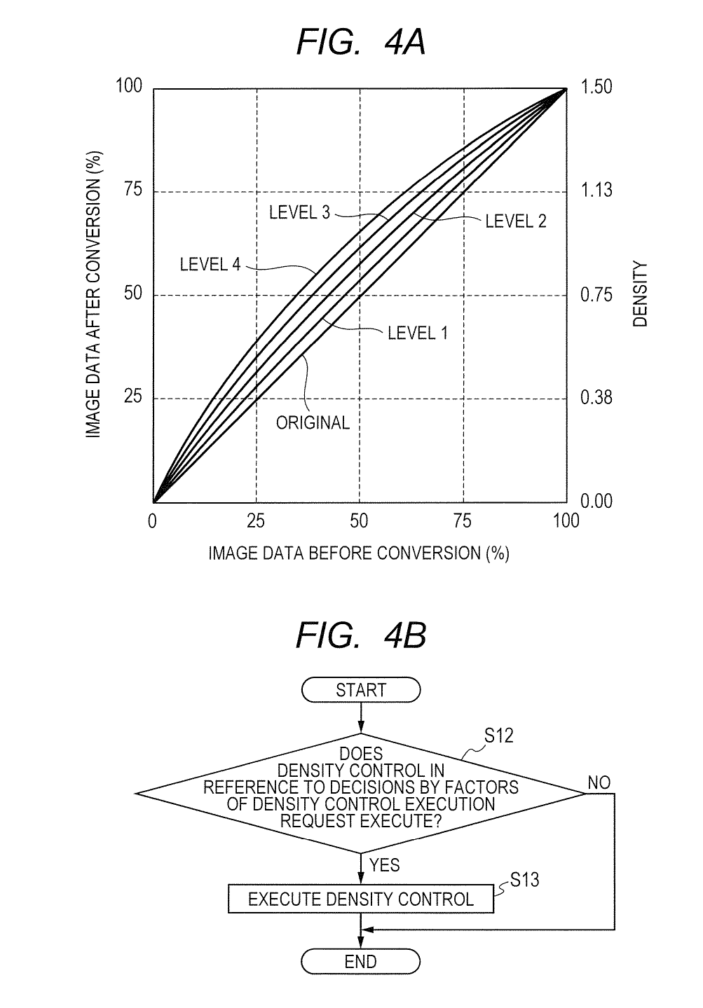

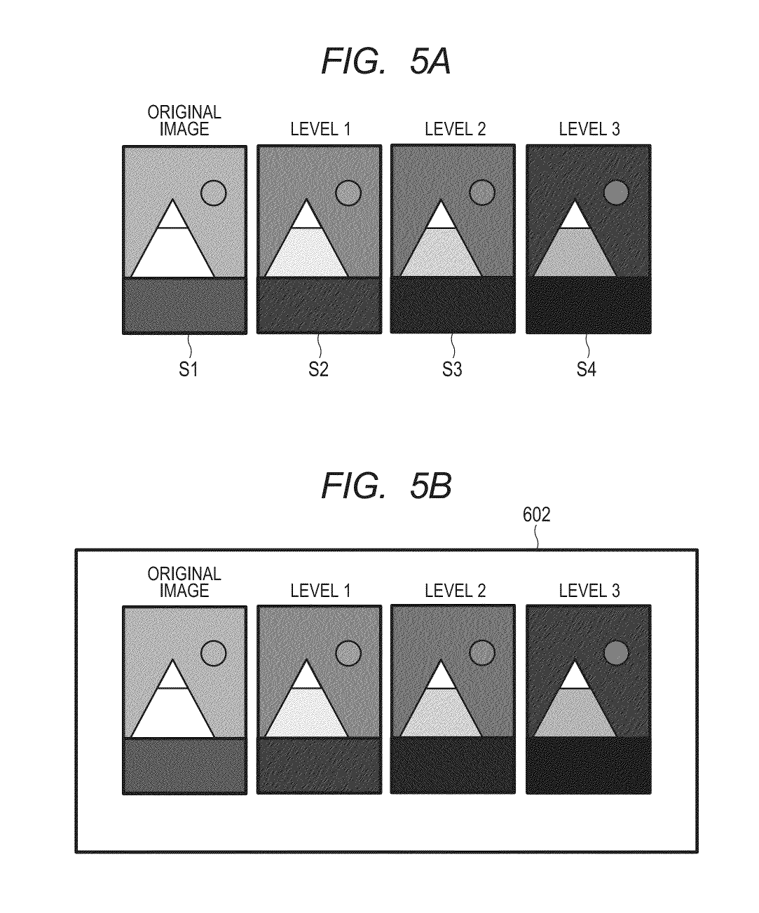

Next, referring to FIG. 3 and FIG. 4A, a method of determining whether or not to execute the image quality maintaining process according to this embodiment is described. In this embodiment, the image forming unit described above forms a plurality of images obtained by changing an index indicating the quality of an image in a stepwise manner. In the processing in FIG. 3, images obtained by changing in advance the level of image quality (hereinafter referred to as “image level”) in a stepwise manner are formed on a plurality of transfer materials S. Then, in the processing in FIG. 3, from among the plurality of images having different image levels, an image having a level for determining an allowable range of the image quality (hereinafter referred to as “allowance level”) is selected, and a selection result is stored into the memory 132 of the controller 122. Note that, the processing of FIG. 3 is executed when, for example, the image forming apparatus is installed, or a user or a service person gives an instruction to execute the processing.

Further, in this embodiment, the density is used as the index indicating the image level, and the density of an image is changed as a change to the image level. FIG. 4A is a graph for showing a relation between image data before conversion and image data after conversion, which is used when a test chart described later is formed. In FIG. 4A, the horizontal, axis represents the image data (%) before conversion and the left vertical axis represents the image data after conversion (%), which is obtained after subjecting the image data to density conversion. Further, in FIG. 4A, the right vertical axis represents the density, and the density corresponding to the image data after conversion (%) is indicated, for example, as follows: image data of 25% corresponds to the density of 0.38, and image data of 75% corresponds to the density of 1.13. Note that, the information of FIG. 4A for showing the relation between the image data before conversion and the image data after conversion (which is also Table 2 described later) is stored into the memory 132 of the controller 122, but may be stored into the memory 606 of the printer engine 121,

In S1, the CPU 131 of the controller 122 instructs the printer engine 121 to execute the density control as the image quality maintaining process (issues an execution command for the density control to the printer engine 121). When instructed by the controller 122 to execute the density control, the printer engine 121 executes the density correction control described above. In this manner, in this embodiment, the density control is executed in S1, and S2 and the subsequent steps are executed under the state in which the density is corrected. Note that, when it is determined that the density correction control does not need to be executed based on a condition such as the number of images that have been formed or a time period that has passed since the previous execution of the density correction control, the processing of S1 does not need to be executed at all times. When the density control by the printer engine 121 is finished, in S2, the CPU 131 instructs the printer engine 121 to form the test charts obtained by changing the density in a plurality of steps. Note that, an image of each of the test charts to be formed by the printer engine 121 is an arbitrary image, and is stored in advance into the memory 132 of the controller 122. Then, the printer engine 121 reads the information stored into the memory 132 via the controller 122, and forms the images of the test charts on the transfer materials S based on the read information.

In this case, the density of the image of each test chart is determined based on the relation between the image data before conversion and image data after conversion, which is shown in FIG. 4A. In this embodiment, in addition to an original image (shown as “original” in FIG. 4A) that is the image data before conversion, four images obtained by increasing the density of the original image in four steps (Levels 1 to 4) are formed on four transfer materials 5, respectively, and five images are output in total. In this case, the original image is an image whose index (density in this embodiment) indicating the quality of an image remains unchanged. Further, as the level number increases from Level 1, the density of the image data after conversion increases, that is, the density at Level 4 is higher than the density at Level 1.

In the relation of the image data shown in FIG. 4A, an association relation between the densities of image data of the original image at specific gradations (0%, 25%, 50%, 75%, and 100%) and the corresponding density after the conversion are shown in Table 2.

TABLE 2

| Original image data [%] | 0 | 25 | 50 | 75 | 100 |
|---|---|---|---|---|---|
| Original image | 0.00 | 0.38 | 0.75 | 1.13 | 1.50 |
| Level 1 | 0.00 | 0.42 | 0.81 | 1.17 | 1.50 |
| Level 2 | 0.00 | 0.47 | 0.87 | 1.22 | 1.50 |
| Level 3 | 0.00 | 0.51 | 0.93 | 1.26 | 1.50 |
| Level 4 | 0.00 | 0.56 | 0.99 | 1.31 | 1.50 |

For example, when the image data of the original image (hereinafter also referred to as “gradation”) is 50%, the density of the original image is 0.75, and the density is changed to 0.81 at Level 1, 0.87 at Level 2, 0.93 at Level 3, and 0.99 at Level 4. Thus, the image data at Level 1 to the image data at Level 4 are each obtained by converting the image data of the original image into image data having higher density than that of the image data of the original image. In this manner, the image formation in which the density is changed in a stepwise manner to change the image level can be realized.

As shown in Table 2, at the gradation of 50%, the density changes by 0.06 when the image level, changes by one level, and thus a density difference of about 0.24 is generated between the original image and the image at Level 4. In this embodiment, when the image level changes by one level (step), the density changes by an increment of 0.06 (step size), and the maximum difference in density from the original image (maximum range) is 0.24, In this way, image density is changed in a stepwise manner. Further, the maximum range of the density difference of 0.24 is determined based on the characteristic of the printer engine 121. Specifically, the maximum range is determined based on the maximum value of the density change that may occur due to, for example, a temporal change or an environmental change when the density correction control is not executed. Further, the maximum range of the density difference and the step size may be arbitrarily selected through an external input by, for ex ample, inputting the maximum range and the step size through the operation unit 603. For example, under a situation in which the density change is allowable, the maximum range of the density difference is set to a large value. In this case, by increasing the step size of the density difference, the number of output test charts (number of printed transfer materials S) can be prevented from increasing. On the other hand, under a situation in which the density change is not allowable, it is only necessary that the maximum range of the density difference be made smaller than the range determined based on the characteristic of the printer engine 121. Note that, although the case is described where the test charts obtained by increasing the image density are formed, test charts obtained by decreasing the image density may be formed. As another example, test charts obtained by increasing the image density and test charts obtained by decreasing the image density may be formed at the same time. Thus, it is only necessary that how to change the density of the test chart be determined in a manner that suits the characteristic of the printer engine 121.

On the test chart according to this embodiment, an identification symbol corresponding to the image level, which is information on the index, is printed. The user assumes the original image as a basis to be compared with another image, and from among the image levels corresponding to a plurality of images obtained by changing the image level, selects the image level to be set as an allowable limit of density stability. More specifically, the user uses the transfer material S on which the original image is formed as the basis to be compared with another image, and from among the following plurality of transfer materials S, selects one transfer material. S to be set as the allowable limit of density stability. Specifically, from among a transfer material S on which an image at Level 1 is formed, a transfer material S on which an image at Level 2 is formed, a transfer material S on which an image at Level 3 is formed, and a transfer material S on which an image at Level 4 is formed, the user selects one transfer material S to be set as the allowable limit of density stability. Note that, although each of the images having different levels of density is formed on one transfer material S in this embodiment, it is not always necessary to form the images having different levels of density on separate transfer materials S. For example, a plurality of images may be formed on one transfer material.

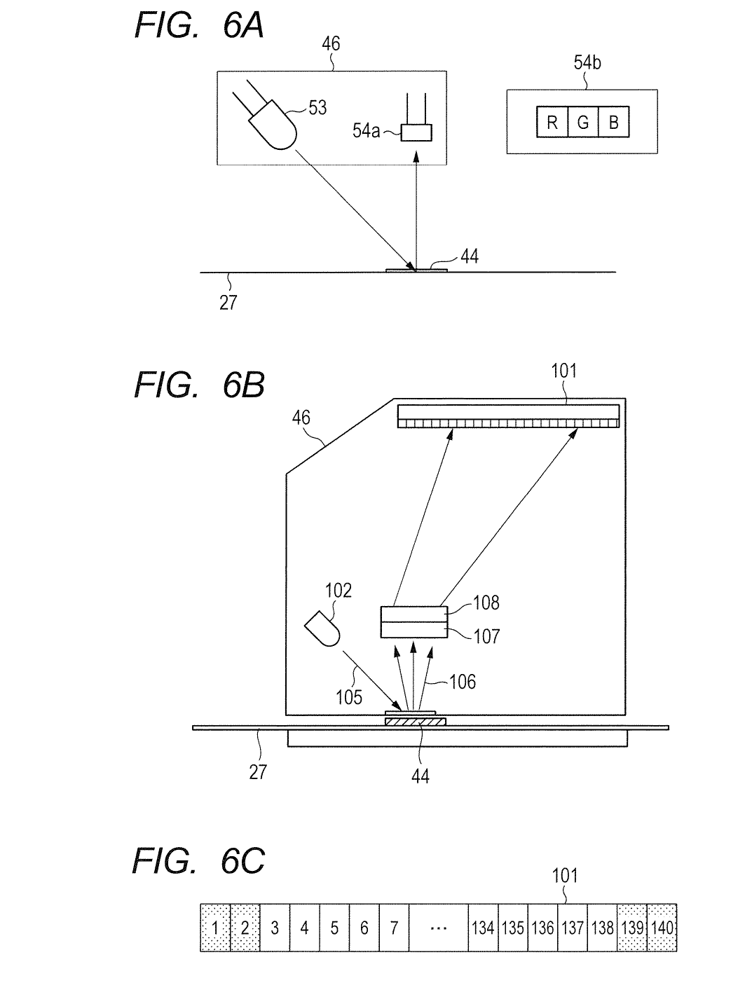

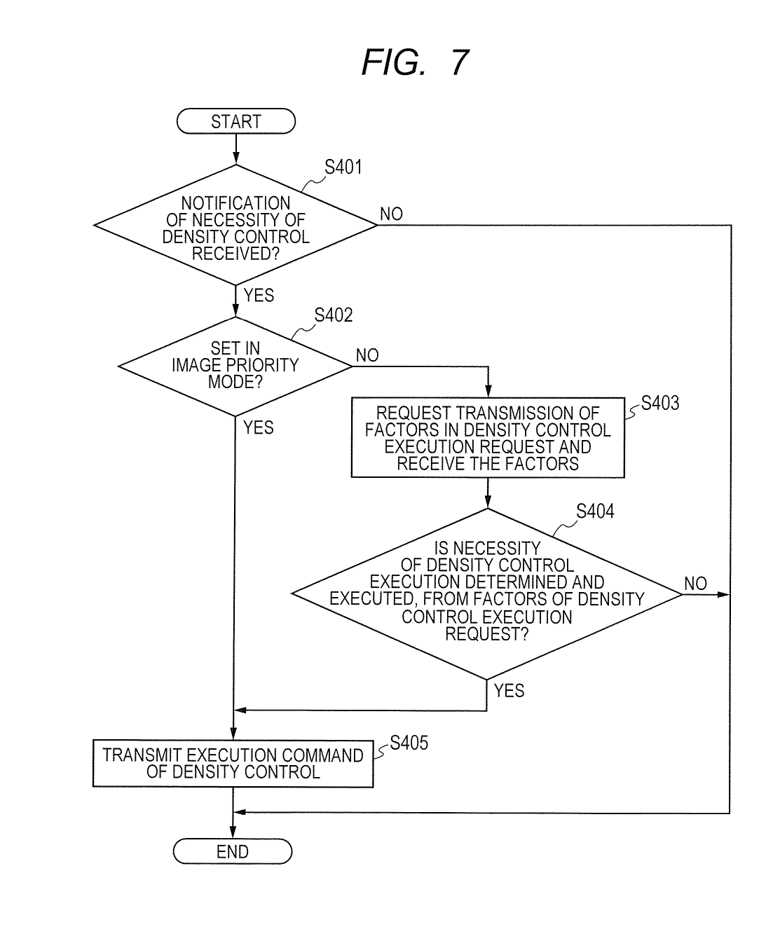

Now, the transfer materials S on which images having different image levels are formed are illustrated in FIG. 5A, FIG. 5A is a diagram for illustrating, from the left, a transfer material S1 on which the original image is formed, a transfer material S2 on which the image at Level 1 is formed, a transfer material S3 on which the image at Level 2 is formed, and a transfer material S4 on which the image at Level 3 is formed. Note that, although the images having different image levels are formed on the transfer materials S in this embodiment, the following configuration may be adopted. Specifically, for example, as illustrated in FIG. 5B, the images having different image levels are displayed on the display unit 602, which is a display of the operation unit 603 of the image forming apparatus, to prompt the user to select an image through the operation unit 603. In this case, the consumption of the transfer materials S can be suppressed. In this manner, as an indicating unit configured to provide a plurality of images obtained by changing the index indicating the quality of the image in a stepwise manner, the images are formed on the transfer materials S, or the images are displayed on the display unit 602 of the operation unit 603.

The user uses the operation unit 603 of the image forming apparatus to input an ID number printed on the test chart corresponding to the selected image level. In S3, the CPU 131 obtains via the printer engine 121 information of the ID number corresponding to the image level of the test chart, which is input through the operation unit 603. The image level obtained by the CPU 131 in S3 is hereinafter referred to as “allowance level”, and in this embodiment, the density control is executed when a density change of the allowance level or more occurs. For example, when Level 3 is selected as the allowance level, density changes of Levels 1 and 2 fall within an allowable range, and hence the density control is not executed. However, the density changes of Levels 3 and 4 are not allowed in this case, and hence the density control is executed. Note that, the ID number corresponding to the image level may be input not only through the operation unit 603 as in the above-mentioned configuration, but also through the host computer 123 connected to the printer.

In S4, based on the obtained information of the ID number, the CPU 131 refers to a “factor of density control execution request and change level” table stored into the memory 132 to determine whether or not to execute the density control for each factor of the density control execution request based on the allowance level. In this case, the “factor of density control execution request and change level” table is the following table. Specifically, with this table, the factor of the density control execution request is matched to the image level (ID number) that is selected by the user and set as the allowable limit to determine information serving as a criterion for determining whether or not to execute the density control. Further, the “factor of density control execution request” means a factor for determining the time to execute the density control, in Table 3, an example of the “factor of density control execution request and change level” table (hereinafter simply referred to as “Table 3”) is shown. Table 3, which is second information, is a table in which the index (density in this embodiment) corresponding to an image selected from among the plurality of images and a determination as to whether or not to execute the density control are associated with each other for each index changed in a stepwise manner.

TABLE 3

| Factor | Level 1 | Level 2 | Level 3 | Level 4 |
|---|---|---|---|---|
| Power is turned on | Executed | Executed | Executed | Not |
| | | | | executed |
| Return from sleep mode | Executed | Executed | Not | Not |
| | | | executed | executed |
| Accumulated number of | Executed | Not | Not | Not |
| printed materials | | executed | executed | executed |
| reaches 100 | | | | |
| Accumulated number of | Executed | Executed | Not | Not |
| printed materials | | | executed | executed |
| reaches 1,000 | | | | |
| Accumulated number of | Executed | Executed | Executed | Not |
| printed materials | | | | executed |
| reaches 3,000 | | | | |
| Accumulated number of | Executed | Executed | Executed | Executed |
| printed materials | | | | |
| reaches 5,000 | | | | |
| Image forming | Executed | Executed | Not | Not |
| apparatus has been | | | executed | executed |
| left unused for | | | | |
| predetermined | | | | |
| time period | | | | |
| Relative humidity | Executed | Not | Not | Not |
| changes by 10% | | executed | executed | executed |
| Relative humdity | Executed | Executed | Not | Not |
| changes by 30% | | | executed | executed |
| Relative humidity | Executed | Executed | Not | Not |
| changes by 50% | | | executed | executed |
| Relative humidity | Executed | Executed | Executed | Executed |
| changes by 70% or more | | | | |
| Process cartridge is | Executed | Executed | Executed | Not |
| replaced | | | | executed |
| Number of transfer | Executed | Not | Not | Not |
| materials that have | | executed | executed | executed |
| been passed after | | | | |
| replacement of process | | | | |
| cartridge reaches 50 | | | | |
| Transfer unit is | Executed | Executed | Not | Not |
| replaced | | | executed | executed |

“Factor of density control execution request and change level” table

In the first column of Table 3, a plurality of factors of the density control execution request are given. Further, in the second to fifth columns of Table 3, for each of Level 1 to Level 4 described above, information on whether or not to execute the density control is stored in association with each of the factors of the first column. For example, at Level 1, information indicating that the density control is “Executed” is stored in association with all of the factors. Further, at Level 4, the information indicating that the density control is “Executed” is stored in association with the factors “Accumulated number of printed materials reaches 5,000” and “Relative humidity changes by 70% or more” but information indicating that the density control is “Not executed” is stored in association with the other factors. Further, in association with the same factor of “Image forming apparatus has been left unused for predetermined time period”, the information indicating that the density control is “Executed” is stored at Levels 1 and 2, but the information indicating that the density control is “Not executed” is stored at Levels 3 and 4. As described above, in this embodiment, according to the image level, the determination as to whether or not to execute the density control differs even for the same factor.

The given factors of the density control execution request include turning on of the power of the image forming apparatus, returning from a sleep mode, the accumulated number of printed materials reaching a predetermined value, and the image forming apparatus having been left unused for a predetermined time period since its power was turned on. Further, the given factors of the density control execution request also include a change in relative humidity reaching a predetermined value, replacement of the process cartridge 51, which is a consumable supply, and the number of transfer materials that have been passed after the replacement of the process cartridge 51 reaching a predetermined value. Note that, the change in relative humidity means an amount of a change from a relative humidity calculated at the time of the previous execution of the density control, and is calculated based on information detected by the temperature moisture sensor 50 of FIG. 1A. Further, the number of transfer materials that have been passed after the replacement of the process cartridge 51 reaching predetermined value is given as the factor because the density change becomes large even in a short time period in some cases after the replacement of the process cartridge 51. Further, the given factors of the density control execution request also include replacement of the transfer unit including the secondary transfer roller 28 and the intermediate transfer belt 27, which are parts to be used in an image forming process.

A density change level corresponding to each of those factors is determined based on a characteristic of the printer engine 121, and the density change level and the image level are associated with each other. Further, the image level and a determination as to whether or not to execute the density control for each factor are associated with each other in Table 3. For example, in the case of a printer engine having the following characteristic: “when the process cartridge 51 is replaced, the density may change by up to Level 3”, the following determination is set. For example, when the allowance level is set to Level 4, the density change due to this factor falls within the allowable range, but when the allowance level is set to Level 1, 2, or 3, the density change due to this factor does not fall within the allowable range. Therefore, the density control is executed when Level 3 or higher (one of Levels 1 to 3) is selected, and the density control is not executed when Level 4 is selected (Table 3). Note that, “Level 3 or higher” in this case means a strict condition including Level 3, and is thus one of Levels 1 to 3.

Further, in the case of a printer engine having the following characteristic: “when the relative humidity has changed by 50% since the previous execution of the density control, the density may change by up to Level 2”, the following determination is set. For example, when the allowance level is set to Level 3 or 4, the density change due to this factor falls within the allowable range, but when the allowance level is set to Level 1 or 2, the density change due to this factor does not fall within the allowable range. Therefore, the density control is executed when Level 2 or higher (Level 1 or 2) is selected, and the density control is not executed when a level lower than Level 2 (Level 3 or 4) is selected (Table 3). Note that, “Level 2 or higher” in this case means a strict condition including Level 2, and is thus Level 1 or 2. Further, the “level lower than Level 2” means a condition having a wider allowable range than that of Level 2, and is thus Level 3 or 4.

In S5, the CPU 131 stores, through overwriting, the determination criterion for the density control execution request into the memory 132 of the controller 122. For example, when the allowance level selected by the user is “Level 3”, the column of “Level 3” of Table 3 is stored into the memory 132 as a new determination criterion for the density control execution request, specifically, as a new table 134. Thus, the CPU 131 also functions as a revision unit configured to revise the table 134 serving as first information. In the above, the configuration is described in which the images obtained by changing the image level in a stepwise manner in advance are formed on the plurality of transfer materials S, and from among the image levels corresponding to the images having different levels of density formed on the plurality of transfer materials S, the allowance level of the image quality is selected, and then the selection result is stored into the memory 132 serving as the storage unit of the image forming apparatus.

[Processing of Changing Execution Frequency of Density Control]

Next, referring to FIG. 4B, control processing according to this embodiment is described in which the execution frequency of the density control is changed based on the determination criterion for the density control execution request (revised table 134) revised by the CPU 131 in S5 of FIG. 3. FIG. 4B is a flowchart for illustrating processing of determining the necessity of the density control based on the determination criterion for the density control execution request. In S12, the CPU 131 of the controller 122 refers to the determination criterion for the density control execution request, which is stored through overwriting into the table 134 of the memory 132 in S5 of FIG. 3 for each printing operation, to determine whether or not to execute the density control. When determining in S12 that the density control is to be executed, in S13, the CPU 131 executes the density control. When determining in S12 that the density control is not to be executed, the CPU 131 ends the processing without executing the density control.

According to the configuration described above, the following effects are achieved. In this embodiment. A user who puts emphasis on the stability of density as the image quality is allowed to increase the execution frequency of the image quality maintaining process, to thereby make a setting for achieving high stability of density. On the other hand, a user who does not put much emphasis on the stability of density is allowed to decrease the execution frequency of the density correction control, to thereby prevent decrease in productivity due to downtime. Further, the range of the density change is based on information selected after the image formed on the transfer material S is confirmed, and is thus high in accuracy and does not exceed the allowable limit. In other words, the setting of the execution frequency of the image quality maintaining process that prevents the range of the density change from exceeding a predetermined range can be realized through one process.

Further, when the user places emphasis on the stability of the image quality to select “Level 1” as the image level, the density correction control is executed for all of the factors as shown in Table 3. Specifically, the density control is executed every time the accumulated number of printed materials reaches 100, and regarding the relative humidity as well, the density control is also executed even when the relative humidity changes by 10% or more, which may occur relatively frequently. Thus, the stabilization of the image quality at the level required by the user who places more emphasis on the stability of the image quality can also be realized. In contrast, when the user places more emphasis on the productivity to select “Level 4” as the image level, the density control is executed when the factor “Accumulated number of printed materials reaches 5,000” or the factor “Relative humidity changes by 70% or more” occurs. In this manner, the setting of minimizing the downtime while satisfying the minimum required image quality can be realized. In this case, the factor “Accumulated number of printed materials reaches 5,000” corresponds to a case where a temporal change in the process components is highly likely to occur, and the factor “Relative humidity changes by 70% or more” corresponds to a case where an excessive environmental change has occurred.

As described above, the image quality maintaining process can be executed at an optimum frequency that suits the image quality required by the user. According to this embodiment, a more appropriate balance between the enhancement of the productivity and the enhancement of the image quality can be selected easily and accurately, and hence the usability can be enhanced. Note that, the image (test chart) to be formed on the transfer material 5, which is formed by using data stored in advance into the image forming apparatus in this embodiment, may be, for example, an image to be actually formed on the transfer material S as required by the user. When the image to be actually formed on the transfer material S as required by the user is used as the test chart, the allowance level can be set with the use of a printed matter to be actually output, and hence a more accurate selection can be realized.

Note that, on the image formed on the transfer material S in S2 of FIG. 3, indices indicating the frequency and time of the density correction control, which are the execution conditions for the image quality maintaining process, may be additionally printed. More information can be provided to the user from the test chart of one transfer material by explicitly indicating the balance between the frequency of the density correction control and the stability of density on the test chart. In this manner, when the user selects the image level, more information to be used for the selection can be provided by additionally providing the time of the density correction control. Further, although the image level is selected by a user in the configuration described above, the image level may be selected by a service person. Further, when a network printer is used as the image forming apparatus, that is, the image forming apparatus is connected to a network to be used by a group of users, the frequency of the density correction control may be set for each of the users. In this configuration, it is only necessary that the image quality maintaining process be executed in accordance with the determination criterion selected by a user who is to execute printing. Moreover, the degree of abnormality of an image at which the user recognizes its abnormality (abnormality recognition level) differs according to also on the type of image. In general, a photographic image and a graphics image are more liable to be affected by the abnormality of the image compared to a text image. The allowance level differs according to the type of image as described above, and hence the time to execute the image quality maintaining process may be determined for each type of image,

Further, there are various use applications of a printed matter. Specifically, for example, there are cases where a printed matter is personally used as a document to be held on hand, a printed matter is a document to be distributed to the third party, and a printed matter is the one to be charged. Further, there are abnormality recognition levels that suit those use applications. Thus, for example, by preparing a plurality of image levels that suit the use applications, the time to execute the image quality maintaining process may be allowed to be selected from among a plurality of options. In such configuration, at the time of printing, the time to execute the image quality maintaining process may be selected through a printer driver while assuming the use application of the printed matter. Further, the factors causing the need to execute the image quality maintaining process and the image levels for each factor that are described this embodiment are an example in the configuration of the image forming apparatus according to this embodiment, and differ according to the configuration of the image forming apparatus to which the present invention is applied.

As described above, according to this embodiment, usability can be enhanced while maintaining image quality.

### Second Embodiment

In a second embodiment of the present invention, registration correction control (also referred to as “registration control”) is described as an image quality maintaining process. In a color image forming apparatus configured to form a color image by superimposing toner images having a plurality of colors one on another, the following matter is given importance in terms of product quality. Specifically, images of respective colors are accurately printed at predetermined positions on a printed matter, that is, prevention of the misregistration. As the factors of the misregistration, for example, there can be given a shift of an irradiation position of light from the scanner 24 and unevenness of an angular velocity of the photosensitive drums 22. In the registration correction control, in order to obtain a positional relation among images of four colors, an image of each color is formed one by one while managing time to start forming the image of each color, and the image of each color is detected by a detection unit, to thereby detect a misregistration amount. In order to detect the misregistration amount, the density sensor 42 is also used for this purpose in many cases, and the misregistration detection is performed by forming a patch for misregistration detection on the intermediate transfer belt 27. That is, similarly to the density correction control, registration correction control is also control that cannot be executed in parallel to the printing operation, and thus needs to be executed independently of the printing operation, which may lower the productivity of printing outputs. Note that, the registration correction control is a known technology, and hence a description thereof is omitted.

[Method of Determining Whether or Not to Execute Image Quality Maintaining Process]

Referring to FIG. 3, Table 4, and FIG. 4B, a method of determining whether or not to execute the registration correction control as the image quality maintaining process is described. Although FIG. 3 and FIG, 4B are illustrations of the density correction control, the method is described by replacing the density correction control by the registration correction control. In S1, the CPU 131 of the controller 122 instructs the printer engine 121 to execute the registration control. When instructed by the CPU 131 to execute the registration control, the printer engine 121 executes the registration control. Note that, similarly to the density correction control, the processing of S1 does not need to be executed at all times when it is determined that the registration control does not need to be executed based on the condition such as the number of images that have been formed or the time period that has passed since the previous execution of the registration control. In S2, when the registration control by the printer engine 121 is finished, the CPU 131 instructs the printer engine 121 to form on the transfer materials S test charts obtained by changing writing positions in a sub-scanning direction in a plurality of steps. In this case, the “sub-scanning direction” means a conveyance direction of the transfer material S.

In this embodiment, one original image and four images obtained by changing the misregistration amount in four steps (Levels 1 to 4), that is, five images in total, are printed. When the image level is changed by one level, the misregistration amount changes by about 40 μm. In other words, images in which the misregistration is intentionally generated are formed on the transfer materials S so that the misregistration amount is about 40 μm at Level 1, about 80 μm at Level 2, about 120 μm at Level 3, and about 160 μm at Level 4. Further, a step of 40 μm of the misregistration amount is determined based on a resolution in the sub-scanning direction.

In S3, the CPU 131 obtains through the operation unit 603 an ID number corresponding to a level that is selected by the user and set as an allowable limit of the misregistration amount. In S4, based on the information of the ID number obtained in S3, the CPU 131 determines a determination as to whether or not to execute the registration control for each factor of a registration control execution request. In this determination, the CPU 131 refers to a “factor of registration control execution request and change level” table of Table 4 (hereinafter simply referred to as “Table 4”) stored into the memory 132 to determine a determination as to whether or not to execute the registration control. In this case, Table 4 is a table with which the factor of the registration control execution request is matched to the allowance level that is selected by the user and set as the allowable limit to determine information serving as a criterion for determining whether or not to execute the registration control. Further, the “factor of registration control execution request” means a factor for determining time to execute the registration control. Table 4, which is the second information, is a table in which the index (misregistration in this embodiment) corresponding to an image selected from among the plurality of images and a determination as to whether or not to execute the registration control are associated with each other for each index changed in a stepwise manner.

TABLE 4

| Factor | Level 1 | Level 2 | Level 3 | Level 4 |
|---|---|---|---|---|
| Power is turned on | Executed | Executed | Executed | Not |
| | | | | executed |
| Return from sleep | Executed | Executed | Not | Not |
| mode | | | executed | executed |
| Image forming | Executed | Executed | Not | Not |
| apparatus has been | | | executed | executed |
| left unused for | | | | |
| predetermined | | | | |
| time period | | | | |
| Temperature inside | Executed | Not | Not | Not |
| image forming apparatus | | executed | executed | executed |
| changes by 5° C. | | | | |
| Temperature inside | Executed | Executed | Not | Not |
| image forming apparatus | | | executed | executed |
| changes by 10° C. | | | | |
| Temperature inside | Executed | Executed | Executed | Not |
| image forming apparatus | | | | executed |
| changes by 30° C. | | | | |
| Temperature inside | Executed | Executed | Executed | Executed |
| image forming apparatus | | | | |
| changes by 50° C. | | | | |
| or more | | | | |
| Process cartridge is | Executed | Executed | Executed | Not |
| replaced | | | | executed |

“Factor of registration control execution request and change level” table

Specific factors causing the misregistration include a change in temperature inside the image forming apparatus. When the temperature inside the image forming apparatus changes to cause a member of the printer engine 121 to expand or contract due to the temperature change, a position on the photosensitive drum 22 where laser light is applied from the scanner 24 changes. For example, in the case of a printer engine having the following characteristic: “when the temperature inside the image forming apparatus changes by 30° C., the misregistration may change by up to 120 μm”, the following determination is set. For example, when the allowance level is set to Level 4 (misregistration amount: 160 μm), the misregistration amount due to this factor falls within the allowable range. However, when the allowance level is set to Level 1 (misregistration amount: 40 μm), Level 2 (misregistration amount: 80 μm), or Level 3 (misregistration amount: 120 μm), the misregistration amount due to this factor does not fall within the allowable range. Therefore, the registration control is executed when Level 3 or higher (one of Levels 1 to 3) is selected, and the registration control is not executed when Level 4 is selected (Table 4). Note that, the temperature inside the image forming apparatus is detected by the temperature moisture sensor 50 of FIG, 1A. Further, “Level 3 or higher” in this case means a strict condition including Level 3, and is thus one of Levels 1 to 3.

In S5, the CPU 131 stores, through overwriting, the determination criterion for the registration control execution request corresponding to the selected level into the table 134 of the memory 132. Thus, the CPU 131 also functions as the revision unit configured to revise the table 134 serving as the first information. Note that, although the registration correction control is executed in S1 before the allowance level is selected in this embodiment, the registration correction control may be executed after the allowance level is selected. As described above, a plurality of images obtained by changing the image level of the misregistration amount in a stepwise manner in advance are output, and the user is prompted to select the allowance level of the image quality from among the image levels corresponding to the plurality of images, and then a result corresponding to the selected allowance level is stored into the table 134 of the image forming apparatus.

[Processing of Changing Frequency of Registration Correction Control]

In S12 of FIG. 4B, the CPU 131 determines the necessity of the registration control based on the determination criterion for the registration control execution request, which is stored through overwriting into the table 134 in 35 of FIG, 3 for each printing operation. When determining in S12 that the registration control is to be executed, the CPU 131 executes the registration control in S13. When determining in S12 that the registration control is not to be executed, the CPU 131 ends the processing without executing the registration control.

As described above, the following effects are achieved in this embodiment. A user who puts more emphasis on the stability of misregistration as the image quality is allowed to increase the execution frequency of the image quality maintaining process, to thereby make a setting for increasing the stability of misregistration. On the other hand, a user who does not put much emphasis on the stability of misregistration is allowed to decrease the execution frequency of the registration correction control, to thereby prevent decrease in productivity due to the downtime. Further, the range of the misregistration change is selected after the image is confirmed, and is thus high in accuracy and does not exceed the allowable limit. In other words, the setting of the execution frequency of the image quality maintaining process that prevents the range of the misregistration change from exceeding a predetermined range can be realized through one process. Note that, the determination as to the necessity of the density correction control execution and the determination as to whether or not to give the instruction to execute the density correction control are described in the first embodiment, whereas the determination as to the necessity of the registration correction control execution and the determination as to whether or not to give the instruction to execute the registration correction control are described in the second embodiment. As other examples of the control to be executed through the image quality maintaining process, in addition to the above-mentioned controls, an adjustment of the balance among color components of a color image, an adjustment of a line width, an adjustment of a solid density, and other such adjustments are also similarly applicable.

As described above, according to this embodiment, the usability can be enhanced while maintaining the image quality.

### Third Embodiment

In the first embodiment, the density correction control involving reading an unfixed toner image by the density sensor 42 is described as the image quality maintaining process. In a third embodiment of the present invention, color correction control executed by a density/chromaticity sensor (hereinafter referred to as “color sensor”) is described. The color sensor is configured to detect a density of a single-color toner image or chromaticity of a full-color image that has been fixed on the transfer material S.

In the color correction control using the color sensor, the final printed matter is detected on the transfer material 5, and hence it is possible to realize more accurate detection than when an unfixed toner image on the photosensitive drum 22 or the intermediate transfer belt 27 is detected. At the same time, the color correction control involves the image forming operation in order to implement the detection by the color sensor, and hence the color correction control cannot be executed in parallel to the normal printing operation and thus needs to be executed independently of the printing operation. In other words, the productivity of printing outputs may be lowered through the execution of the color correction control on the transfer material S.

FIG. 6A is a diagram for illustrating a configuration of a color sensor 46 of a filter type. The color sensor 46 includes, for example, a white light source as a light emitting element 53 serving as a light source, and further includes a light receiving element 54a. The light receiving element 54a is formed of an element group 54b provided through intermediation of three types of filters having different spectral transmission characteristics, such as those for red (R), green (G), and blue (B). The density of the respective toner colors can be detected based on RGB outputs obtained by the color sensor 46 of the filter type. Further, the RGB outputs obtained by the color sensor 46 may be subjected to mathematical processing, to thereby approximate the chromaticity. Note that, the color sensor 46 may be a spectrophotometric type color sensor.

FIG. 6B is a diagram for illustrating a configuration of the spectrophotometric type color sensor 46. In the case of the spectrophotometric type color sensor 46, white light 105 is applied to a toner patch 44 from a light emitting element 102. The white light 105 applied to the toner patch 44 is reflected by the toner patch 44, and reflected light 106 is dispersed by a diffraction grating 108 via a collecting lens 107. Note that, the reflected light 106 may be dispersed by a prism. Further, the toner patch 44 may be formed as a single-color toner image with the use of single-color toner, or may be formed as a mixed-color toner image by mixing toner images of a plurality of colors. A line sensor 101 detects the intensity of dispersed light, which is dispersed by the diffraction grating 108 for each wavelength range. The line sensor 101 is a sensor configured to detect light whose wavelength falls within a predetermined range at predetermined intervals, and a configuration of the line sensor 101 is illustrated in FIG. 6C. The line sensor 101 is formed of effective pixels numbered from “3” to “138” and four dark pixel in total (1, 2, 139, and 140), which are arranged on end portions of the line sensor 101 in order to correct a dark output and reduce variation among elements by enhancing symmetry of the effective pixels. A spectral reflectance of the toner patch 44 is obtained based on the intensity detected by the line sensor 101 after a wavelength distribution of the light emitted from the light source and a spectral response of the sensor are corrected. When the spectral reflectance is obtained by the spectrophotometric type color sensor 46 in this manner, an absolute chromaticity value such as CIE-XYZ or CIE-Lab can be calculated based on the obtained spectral reflectance.

When the density or chromaticity of the toner patch 44 on the transfer material S is obtained, there are various methods of controlling the obtained density or chromaticity. For example, the color separation table is corrected based on the obtained density. As another example, the color matching table, the color separation table, or the like stored into the memory 132 is corrected based on the obtained chromaticity. Note that, the correction method is known, and hence a detailed description thereof is omitted.

[Method of Determining Whether or Not to Execute Image Quality Maintaining Process]

Referring to FIG. 3, Table 5, and FIG. 4B, a method of determining whether or not to execute, as the image quality maintaining process, density control of a single-color toner image on the transfer material (hereinafter referred to as “on-transfer material density control”), which is an example of the color correction control on the transfer material S, is described. The on-transfer material density control is control in which the color separation table is corrected based on the density of the toner patch 44 on the transfer material S. Further, although FIG. 3 and FIG. 4B are illustrations of the density correction control of an unfixed toner image, the method is described by replacing the density correction control by the on-transfer material density control.

In S1, the CPU 131 of the controller 122 instructs the printer engine 121 to execute the on-transfer material density control. When instructed by the CPU 131 to execute the on-transfer material density control, the printer engine 121 forms the toner patch 44 on the intermediate transfer belt 27, to thereby execute the density correction control of an unfixed toner image. After the density of the unfixed toner image is adjusted to an appropriate level by executing the density correction control, the color toner patch 44 is transferred onto the transfer material S and then subjected to fixing processing. Then, the on-transfer material, density control is executed.

In S2, when the on-transfer material density control by the printer engine 121 is finished, the CPU 131 instructs the printer engine 121 to form on the respective transfer materials S test charts obtained by changing the density in a plurality of steps. The printer engine 121 reads information stored into the memory 132, and forms the test charts based on the read information. In this case, the image density of the test chart is determined based on the relation between the image data before conversion and the image data after conversion, which is shown in FIG. 4A.

In S3, the CPU 131 obtains through the operation unit 603 an ID number corresponding to a level that is selected by the user and set as the allowable limit of density stability. In S4, based on the information of the ID number obtained in S3, the CPU 131 determines a determination as to whether or not to execute the on-transfer material density control for each factor of an on-transfer material density control execution request. At this time, the CPU 131 refers to a “factor of on-transfer material density control execution request and change level” table of Table 5 (hereinafter simply referred to as “Table 5 ” stored into the memory 132 to determine a determination as to whether or not to execute the on transfer material density control. In this case, Table 5 is a table with which the factor of the on-transfer material density control execution request is matched to the allowance level that is selected by the user and set as the allowable limit to determine information serving as a criterion for determining whether or not to execute the on transfer material density control. Further, the “factor of on-transfer material density control execution request” means a factor for determining time to execute the on transfer material density control. Table 5, which is the second information, is a table in which the index (density on the transfer material S in this embodiment) corresponding to an image selected from among the plurality of images and a determination as to whether or not to execute the on-transfer material density control are associated with each other for each index changed in a stepwise manner.

TABLE 5

| Factor | Level 1 | Level 2 | Level 3 | Level 4 |
|---|---|---|---|---|
| Transfer unit is | Executed | Executed | Not | Not |
| replaced | | | executed | executed |
| Fixing device is | Executed | Executed | Not | Not |
| replaced | | | executed | executed |
| Transfer material | Executed | Executed | Executed | Not |
| is changed | | | | executed |

Factors causing the change in density on the transfer material S include replacement of the transfer unit including the secondary transfer roller 28 and the intermediate transfer belt 27, replacement of the fixing device 30, and a change in the type of the transfer material S. The image level and a determination as to whether or not to execute the on-transfer material, density control for each factor is associated with each other in Table 5. For example, in the case of a printer engine having the following characteristic: when the fixing device 30 is replaced, the density on the transfer material S may change by up to Level 2, the following determination is set. For example, when the allowance level is set to Level 4 or 3, the density change due to this factor falls within the allowable range, but when the allowance level is set to Level 1 or 2, the density change due to this factor does not fall within the allowable range. Therefore, the density control is executed when Level 2 or higher (Level 1 or 2) is selected, and the density control is not executed when Level 3 or lower (Level 3 or 4) is selected.

Further, the factors causing the change in density on the transfer material S also include the change in type of the transfer material. Specifically, the density on the transfer material S may be changed due to, for example, a change in electrical resistance, surface roughness, or material of the transfer material, which are physical properties thereof. It is desired from the viewpoint of color stability that the on-transfer material density control be executed when the transfer material S is changed by the user. However, in this embodiment, for example, only when the user puts emphasis on the productivity to select Level 4, the on-transfer material density control is not executed.

In S5, the CPU 131 stores, through overwriting, the determination criterion for the on-transfer material density control execution request corresponding to the selected level into the table 134 of the memory 132. Thus, the CPU 131 also functions as the revision unit configured to revise the table 134 serving as first information. As described above, a plurality of images obtained by changing the image level in a stepwise manner in advance are output, and the user is prompted to select the allowance level of the image quality from among the image levels corresponding to the plurality of images, and then a result corresponding to the selected allowance level is stored into the table 134 of the image forming apparatus.

[Processing of Changing Frequency of On-Transfer Material Density Control]

In S12 of FIG. 4B, the CPU 131 determines the necessity of the on-transfer material density control based on the determination criterion for the on-transfer material density control execution request, which is stored through overwriting into the table 134 in S5 of FIG, 3 for each printing operation. When determining in S12 that the on-transfer material density control is to be executed, the CPU 131 executes the on-transfer material density control in S13. When determining in S12 that the on-transfer material density control is not to be executed, the CPU 131 ends the processing without executing the on-transfer material density control.

As described above, according to this embodiment, the usability can be enhanced while maintaining the color stability as the image quality.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-034126, filed Feb. 24, 2015, which is hereby incorporated by reference herein in its entirety.

What is claimed is:

1. An image forming apparatus configured to execute image adjusting control, comprising:
an indicating unit configured to indicate a plurality of images in each of which an index related to quality of an image is changed in a stepwise manner; and
a determination unit configured to determine whether or not the image adjusting control is to be executed based on the index corresponding to an image selected from among the plurality of images and on information on whether or not the image adjusting control is to be executed, the information being set for each index changed in a stepwise manner.

2. An image forming apparatus according to claim 1, further comprising a revision unit configured to revise, based on the information on whether or not the image adjusting control is to be executed, information in which, for each factor for determining time to execute the image adjusting control, a determination as to whether or not the image adjusting control is to be executed. :is associated with the each factor.

3. An image forming apparatus according to claim 1, wherein the indicating unit comprises a forming unit configured to form an image on a transfer material.

4. An image forming apparatus according to claim 1, wherein the indicating unit comprises a display unit configured to display an image on a display.

5. An image forming apparatus according to claim 1, wherein a timing of the image adjusting control is changed according to the index corresponding to the selected image.

6. An image forming apparatus according to claim 5, wherein the timing is adjustable according to an image type.

7. An image forming apparatus according to claim
wherein the indicating unit is configured to provide an image having the index that remains unchanged, and
wherein the selected image comprises an image selected by comparing the image having the index that remains unchanged with images obtained by changing the index in a stepwise manner.

8. An image forming apparatus according to claim 1, further comprising an input unit configured to input information on the index corresponding to the selected image.

9. An image forming apparatus according to claim 1, wherein the indicating unit is configured to provide an image containing information on the index.

10. An image forming apparatus according to claim 1, further comprising a storage unit configured to store information in which, for each factor for determining time to execute the image adjusting control, a determination to whether or not the image adjusting control is to be executed is associated with the each factor.

11. An image forming apparatus according to claim 1,
wherein the image adjusting control comprises density correction control for correcting density of an image, and
wherein the index comprises the density.

12. An image forming apparatus according to claim 1,
wherein the image adjusting control comprises registration correction control for correcting misregistration, and
wherein the index comprises an amount the misregistration.

13. An image forming apparatus according to claim 1,
wherein the image adjusting control comprises control to be executed by a color sensor, and
wherein the index comprises chromaticity.

14. A method of controlling an image forming apparatus configured to execute image adjusting control, the method comprising:
indicating, by an indicating unit, a plurality of images in which an index related to quality of an image is changed in a stepwise manner;
selecting one image from among the plurality of images; and
determining whether or not the image adjusting control is to be executed based on the index corresponding to the selected image and on information on whether or not the image adjusting control is to be executed, the information being set for each index changed in a stepwise manner.

15. A method of controlling an image forming apparatus according to claim 14, further comprising revising, based on the information on whether or not the image adjusting control is to be executed, information in which, for each factor for determining time to execute the image adjusting control, a determination as to whether or not the image adjusting control is to be executed is associated with the each factor.

16. A method of controlling an image forming apparatus according to claim 14, wherein the indicating unit comprises one of a forming unit configured to form an image on a transfer material, and a display unit configured to display an image on a display.

17. A method of controlling an image forming apparatus according to claim 14, wherein a timing of the image adjusting control is changed according to the index corresponding to the selected image, and
wherein the timing is adjustable according to an image type.

18. A method of controlling an image forming apparatus according to claim 14,
wherein the providing of the plurality of images comprises providing an image having the index that remains unchanged, and
wherein the selecting of the one image comprises selecting an image by comparing the image having the index that remains unchanged with images obtained by changing the index in a stepwise manner.

19. A method of controlling an image forming apparatus according to claim 14, further comprising inputting, by an input unit, information on the index corresponding to the selected image.

20. A method of controlling an image forming apparatus according to claim 14, wherein the providing of the plurality of images comprises providing an image containing information on the index.

21. A method of controlling an image forming apparatus according to claim 14, further comprising storing, in a storage unit, information in which, for each factor for determining time to execute the image adjusting control, a determination as to whether or not the image adjusting control is to be executed is associated with the each factor.

22. A method of controlling an image forming apparatus according to claim 14,
wherein the image adjusting control comprises one of density correction control for correcting density of an image, registration correction control for correcting misregistration, and control to be executed by a color sensor,
wherein the index comprises the density when the image adjusting control is the density correction control,
wherein the index comprises an amount of the misregistration when the image adjusting control is the registration correction control, and
wherein the index comprises chromaticity when the image adjusting control is the control to be executed by the color sensor.
